(19) United States
(12) Patent Application Publication
(10) Pub. No.: US 2011/0246882 A1
(43) Pub. Date: Oct. 6, 2011

(54) VISUAL ENTERTAINMENT TIMELINE

(75) Inventors: Sean Kollenkark, Seattle, WA (US); Benjamin Nicholas Alton, Seattle, WA (US); Cory Cirrincione, Bellevue, WA (US); Doug Berrett, Seattle, WA (US); Joe McClanahan, Redmond, WA (US); Edwin Thorne, III, Seattle, WA (US); Zerelina R. Mukherjee, Redmond, WA (US)

(73) Assignee: Microsoft Corporation, Redmond, WA (US)

(21) Appl. No.: 12/749,868

(22) Filed: Mar. 30, 2010

(51) Int. Cl. G06F 15/16; G06F 3/01

(52) U.S. Cl. 715/716; 709/203

(57) ABSTRACT

Embodiments are disclosed herein that relate to the presentation of an entertainment consumption history via a timeline. For example, one embodiment comprises receiving entertainment consumption history comprising one or more entertainment content identifiers each identifying one or more entertainment content items sent to a selected user. The entertainment consumption history also comprises, for each entertainment content identifier, information related to a time at which the one or more entertainment content items identified by the entertainment content identifier were sent to the selected user. The embodiment further comprises sending to a display device a graphical depiction of the entertainment consumption history data as a timeline with each entertainment content identifier being illustrated along a direction of a time axis at a location representative of the time at which the one or more entertainment content items represented by the entertainment content identifier were sent to the selected user.

### BACKGROUND

Entertainment content may be obtained and consumed in many different ways, including but not limited to, via digital and analog broadcast television, digital and analog cable television, satellite television, Internet Protocol (IP) television, via time-shifting devices such as digital video recorders (DVR), etc.

Many systems for providing and consuming entertainment content may maintain a history of media items consumed or otherwise accessed by a user. A user that wishes to view information on previously-consumed entertainment content may view such a history to attempt to find desired information. However, such histories may store limited information dating back for a relatively short period of time. Further, such histories may be presented as a simple list view (e.g. in drop-down format) that may be difficult to browse if the list contains many items.

### SUMMARY

Accordingly, various embodiments are disclosed herein that relate to the presentation of entertainment consumption history information. For example, one disclosed embodiment provides a computer-readable medium comprising instructions stored thereon that are executable by a computing device to receive entertainment consumption history comprising one or more entertainment content identifiers each identifying one or more entertainment content items sent to a selected user. The entertainment consumption history also comprises, for each entertainment content identifier, information related to a time at which the one or more entertainment content items identified by the entertainment content identifier were sent to the selected user. The instructions are further executable to send to a display device a graphical depiction of the entertainment consumption history data as a timeline with each entertainment content identifier being illustrated along a direction of a time axis at a location representative of the time at which the one or more entertainment content items represented by the entertainment content identifier were sent to the selected user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a network entertainment environment.

FIG. 2 shows an embodiment of a entertainment consumption timeline depicted at a first level of zoom.

FIG. 3 shows the embodiment of FIG. 2 at a second, more detailed level of zoom.

FIG. 4 shows another embodiment of an entertainment consumption timeline after user selection of a pivot.

FIG. 5 shows a flow diagram depicting an embodiment of a method for presenting a entertainment consumption timeline.

FIG. 6 shows a flow diagram depicting another method for presenting a entertainment consumption timeline.

### DETAILED DESCRIPTION

As mentioned above, current histories maintained by various media provision and consumption systems may store entertainment consumption data dating back for a relatively short period of time, such as weeks or months. Further, such histories also may be presented as simple lists through which a user must scroll. To facilitate searching, such lists may be organized as a series of folders arranged by day, week, month, etc. to facilitate scrolling and manual searching. However, such views do not enable a user to look back in time to see a long term, comprehensive view of an entertainment consumption history. For example, using current histories, a user may not be able to easily answer various questions a user may have about his or her entertainment consumption history, such as: “what was that band that I listened to my senior year of high-school?,” “have I ever seen “movie x,” “what movies have I seen that star actor x,” “take me back to my favorite bands from five years ago,” etc.

Likewise, current media histories may not provide any easy way for users to look forward to discover upcoming entertainment options that they may be interested in, such as suggestions for television shows to record, upcoming media releases, concerts, etc. Accordingly, embodiments are disclosed herein that allow a user to view a visual entertainment consumption timeline that illustrates entertainment consumed by that user, or by another user that has elected to share his or her entertainment history, graphically as an interactive timeline. For example, in some embodiments, a user may zoom a view of the timeline out to display information regarding genres, artists, and other such general information on media enjoyed by the user over relatively longer time periods. Likewise, a user may zoom a view of the timeline in to display information regarding specific entertainment items consumed by the user during relatively shorter time periods. Further, past entertainment consumption of the user may be analyzed to produce future entertainment recommendations for the user, which may be displayed in a future region of the timeline.

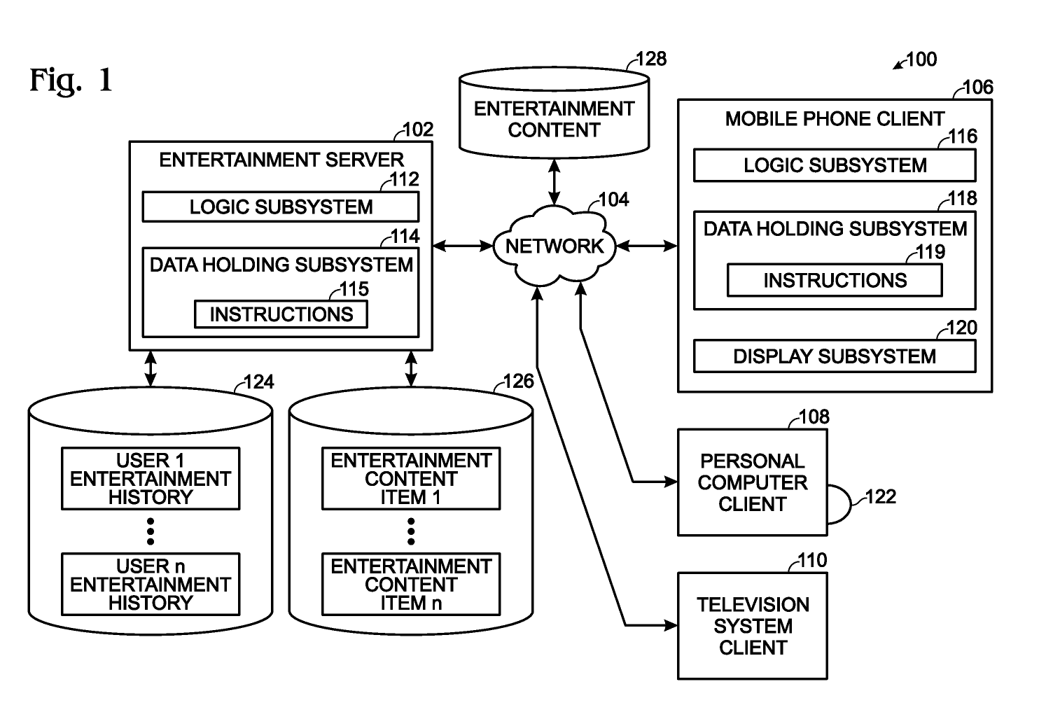

FIG. 1 shows an example embodiment of a use environment 100 for the consumption of entertainment content. Use environment 100 comprises an entertainment server 102 configured to provide entertainment content and entertainment history data to client devices over a network 104. FIG. 1 illustrates three example client devices as a mobile device client 106, a personal computer client 108, and a television system client 110. Each of these client devices may be configured to receive and present any suitable type of entertainment content, including but not limited to audio content, video content, web content, still images, etc. Examples of personal computer clients include, but are not limited to, clients running on desktop, laptop, notebook, and notepad computing devices. Examples of suitable mobile device clients include, but are not limited to, clients running on smart phones, personal digital assistants, portable media players, global positioning systems, and other such mobile computing devices.

Entertainment server 102 comprises a logic subsystem 112, and a data-holding subsystem 114. Logic subsystem 112 may include one or more physical devices configured to execute one or more computer-readable instructions, including but not limited to the embodiments related to the presentation of an entertainment consumption timeline described in more detail hereafter. Such instructions may be part of one or more programs, routines, objects, components, data structures, or other logical constructs. Additionally, such instructions may be implemented to perform a task, implement a data type, transform the state of one or more devices, or otherwise arrive at a desired result. Logic subsystem 112 may include one or more processors that are configured to execute software instructions. Additionally or alternatively, logic subsystem 112 may include one or more hardware or firmware logic machines configured to execute hardware or firmware instructions. Logic subsystem 112 may optionally include individual components that are distributed throughout two or more devices, which may be remotely located in some embodiments.

Data-holding subsystem 114 may include one or more computer-readable storage devices configured to hold data and/or instructions 115, such as applications, executable by the logic subsystem to implement the herein described methods and processes. When such methods and processes are implemented, the state of data-holding subsystem 114 may be transformed (e.g., to hold different data). Data-holding subsystem 114 may include removable computer-readable media and/or built-in computer-readable media. Data-holding subsystem 114 may include optical memory devices, semiconductor memory devices, and/or magnetic memory devices, among others. Data-holding subsystem 114 may include devices with one or more of the following characteristics: volatile, nonvolatile, dynamic, static, read/write, read-only, random access, sequential access, location addressable, file addressable, and content addressable.

The client devices also include logic and data storage components, as well as other suitable components. FIG. 1 illustrates these features with respect to mobile device client 106, which is shown as including a logic subsystem 116, a data-holding subsystem 118, and a display subsystem 120. Logic subsystem 116 of client computing device 106 may include one or more physical devices configured to execute one or more instructions to perform such functions as presenting an entertainment consumption timeline, as described in more detail below. Likewise, data-holding subsystem 118 may include instructions 119 stored thereon that are executable by logic subsystem 116 to perform various tasks, including but not limited to the embodiments described herein of presenting an entertainment consumption timeline.

Display subsystem 120 may be used to present a visual representation of data held by data-holding subsystem 118, for example, in the form of an entertainment consumption timeline. As the herein described methods and processes change the data held by the data-holding subsystem, and thus transform the state of the data-holding subsystem, the state of display subsystem 120 may likewise be transformed to visually represent changes in the underlying data. Display subsystem 120 may include one or more display devices utilizing virtually any type of technology. Depending upon the configuration of any particular client, a display device may be combined with logic subsystem 116 and/or data-holding subsystem 118 in a shared enclosure, or may be peripheral.

Any of client devices 106, 108, 110 and/or entertainment server 102 may optionally include, or be configured to accept insertion of or connection to, computer-readable removable media, shown schematically at 122 in FIG. 1. Examples of such computer-readable removable media include, but are not limited to, DVD (digital versatile disk), tape drives, solid state memory such as flash memory, etc. Further, it will be understood that each of these devices may include other components not shown in FIG. 1.

FIG. 1 further shows a user media history database 124 and an entertainment content database 126 in communication with entertainment server 102. Entertainment history database 124 may store information related to a plurality of users' entertainment consumption pasts, including but not limited to information on music, audio/video, game, live concert, etc. content previously consumed by a plurality n of users. Entertainment content database 126 includes entertainment content items that a user may access via entertainment server 102. It will be understood that entertainment history database 124 may include information on user-consumed entertainment content that is not stored in entertainment content database 126 or available from entertainment server 102, but that are instead received from third party providers (as illustrated at 128 in FIG. 1), or provided by users themselves.

Any of client devices 106, 108, and 110 may be configured to request and display an entertainment consumption timeline. Such a timeline may be requested and displayed in any suitable use scenario. For example, such a timeline may be presented whenever a user requests the display of a consumption history, upon a user request to view a content discovery interface, etc. Also, such a timeline may be presented as a primary user interface feature, or as an embedded feature on another user interface.

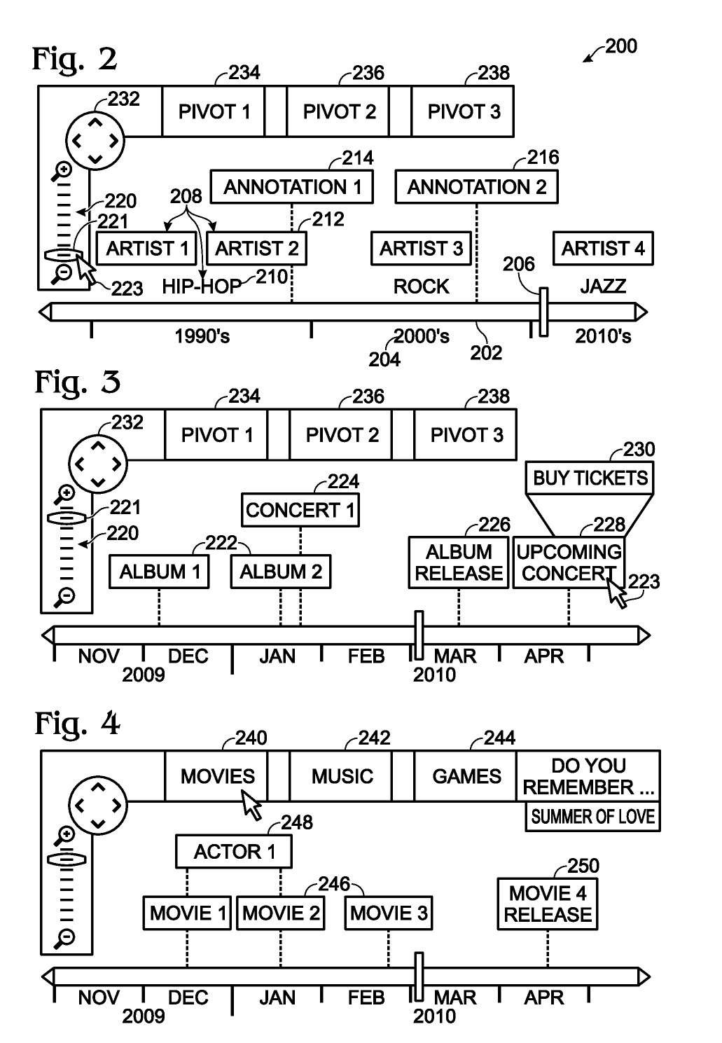

FIG. 2 shows an embodiment of an entertainment consumption timeline 200. Entertainment consumption timeline 200 comprises a graphical illustration of a time axis 202, and time values 204 arranged along the time axis. The time values 204 illustrates a time scale (e.g. hours, days, weeks, months, years, decades, etc.) that is currently being displayed, and also values within that scale. In the example of FIG. 2, the time scale is depicted as decades. Further, a location of the present time is illustrated by a present time mark 206. While time axis 202 is illustrated in FIG. 2 as a straight line along a horizontal direction, it will be understood that the time axis may have any other suitable shape (including curved, polycurved, non-continuous, etc.), and may have any suitable orientation on a display. Further, in some embodiments, the time axis may not be explicitly shown on the display, but instead may be implied by an arrangement and ordering of information on the display.

Various entertainment content identifiers 208 are shown positioned above the time axis 202. The entertainment content identifiers 208 positioned to the left of present time mark 206 each identifies one or more media items that were sent to and received by the user in the past. In the specific embodiment of FIG. 2, the long time frame spanned by time axis 202 may make it difficult to show all entertainment content items sent to the user over that time, as the volume of information may be difficult to display in an easy-to-read manner. Therefore, each entertainment content identifier 208 in FIG. 2 identifies a common characteristic of entertainment content items consumed by the user in or around the interval in time on time axis 202 adjacent to that entertainment content identifier 208. FIG. 2 shows two such examples of entertainment content identifiers 208 in the form of genre indicators 210 and artist indicators 212. Genre indicators 210 indicate genres of entertainment enjoyed by the user during different time frames in the user's past, and artist indicators 212 indicate artists to whom the user listened with a selected frequency in such different time frames.

While FIG. 2 shows four example artist indicators and three example genre indicators, it will be understood that any suitable number, and any suitable type of, entertainment content identifier may be displayed. For example, in the context of FIG. 2, where relatively large numbers of entertainment content identifiers are displayed with respect to a relatively small portion of time axis 202, the entertainment content identifiers may be arranged along a vertical axis (referring to the orientation of FIG. 2) such that a user may scroll vertically to view the entertainment content identifiers.

In some embodiments, a user may have the ability to annotate an entertainment consumption guideline with notes, events, etc. Such annotations are illustrated in FIG. 2 at 214 and 216 as annotation 1 and annotation 2, respectively. As an example, a user may wish to annotate an entertainment consumption timeline with the user's wedding date, college graduation date, a date of an important world event, etc. This may allow the user to later view the entertainment consumption timeline to rediscover the entertainment content that was consumed around such events.

FIG. 2 also illustrates examples of various user interface controls that may be used to interact with entertainment consumption timeline 200. For example, a zoom control 220 is shown as a user interface control comprising a series of marks arranged between a “zoom in” symbol and a “zoom out” symbol, wherein the zoom in and zoom out symbols take the form of magnifying glasses with a “+” and “−” symbol, respectively. A user may reveal or hide levels of detail within entertainment consumption timeline 200 with zoom control 220 by moving a zoom control slider 221 relative to the zoom in and zoom out symbols. This is illustrated in FIG. 3, which shows zoom control slider 221 moved closer to the zoom out symbol than in FIG. 2. As a result of this movement of zoom control slider 221 (for example, via a cursor 223), the time scale of time axis 202 changes from decades to months. Further, media content identifiers 222 that each identifies a single media content item sent to the user are displayed along time axis 202.

In the depicted embodiment, the single media content items are shown as albums sent to the user (e.g. by downloading from entertainment server 102), but it will be understood that media content identifiers 222 may identify any other suitable type of media content item. Examples include, but are not limited to, songs, movies, television shows, podcasts, etc. Media content identifiers 222 also may identify media events attended by the user. For example, if the user purchases a concert ticket via an online service, information on the concert may be stored and presented as a part of the user's entertainment consumption timeline, as shown at 224.

FIG. 3 also shows an example of future entertainment content items displayed along time axis 202. As mentioned above, past entertainment consumption of the user may be analyzed to produce future entertainment recommendations for the user, which may be displayed in a future region of time axis 202. Here, an album release date 226 and upcoming concert 228 determined to be of potential interest to the user are displayed in a future region of time axis 202. The identification of future entertainment recommendations may be performed in any suitable manner. For example, in some embodiments, future recommended entertainment content items may be determined from information explicitly provided by a user. Alternatively or additionally, recommendations may be determined from analysis of a user's prior entertainment consumption history data.

In some embodiments, various entertainment content indicators may act as user interface controls that enable a user to launch an experience related to the identified content. For example, if a user wishes to listen to an album shown by an entertainment content indicator, a user may be able to launch playback of the album by selecting the entertainment content indicator (e.g. by touch input, by cursor, etc.). Upon receipt of such a user input, entertainment server 102 may be contacted with a request for the item, and the item may be received and then presented by the client. Likewise, as illustrated in FIG. 3, if a user wishes to purchase tickets for an upcoming concert, the user may select the upcoming concert entertainment content indicator, as illustrated at 230, to launch a ticket sales service. It will be understood that these examples are described for the purpose of illustration, and are not intended to be limiting in any manner.

Entertainment content identifiers 208 may take any suitable form that enable user interaction with the entertainment content identifiers. For example, in some embodiments, an entertainment content identifier 208 may comprise a pointer to a record in a database which includes metadata related to a content item and a location of the actual content itself. Such a content identifier 208 may have a relatively small size, and thus consume less network and client resources during transmission than the transmission of the corresponding content item. In other embodiments, the entertainment content identifiers 208 may take any other suitable form.

In some cases, such as with 3rd party content sources, an entertainment content item represented by an entertainment content identifier may not be locatable or accessible. In this case, a database to which the entertainment content identifier points may include only the title and other metadata. However, to provide for an interactive user experience in this instance, a matching process may be used to determine whether the content is available from another location (e.g. is stored on a user's system, or available via another service to which the user has access), and then play that copy of the content item instead.

Returning briefly to FIG. 2, FIG. 2 also shows a pan control 232. A user may make a user input selecting the pan control to cause, in response to the user input, the user interface to change a location (e.g. dates or times of the start and end of the timeline) of the time interval displayed by the timeline, without changing a length of the displayed time interval. This may allow a user to pan the timeline to see information that is outside the scope of a current view due to the information being either too far in the past or too far in the future to appear in a currently displayed time interval. In the depicted embodiment, pan control 232 includes both vertical and horizontal pan selectors. This may allow a user to pan through vertically scrollable entertainment content identifiers, as well as along entertainment consumption timeline 200. It will be understood that any other suitable controls may be used to pan, zoom, etc. For example, gestures may be used to perform these functions in a touch-based input system. Likewise, a depth-sensing camera may be used as an input device to accept user inputs in the form of body motions.

Additionally, FIG. 2 shows three generically depicted pivot controls 234, 236, 238 that a user may select to search on a desired pivot. Pivot controls 234, 236, 238 may comprise preselected search and/or filtering criteria that allows a user to easily view specific information in entertainment consumption timeline 200. For example, pivot controls 234, 236, 238 may allow a user to select specific types of media content to be displayed in entertainment consumption timeline 200. As a more specific example, FIG. 4 shows a plurality of pivot controls configured to select a media type. The depicted controls comprise a “movie” pivot control 240 may be configured to display movie and video information in entertainment consumption timeline 200, a “music” pivot control 242 may be configured to display music information, and a “games” pivot control 244 may be configured to display game information. In this case, a user may select one of the pivots, and the corresponding information may be displayed in entertainment consumption timeline 200. It will be understood that these specific pivots are presented for the purpose of example, and are not intended to be limiting in any manner.

FIG. 4 illustrates the selection of the “movie” pivot control 240 via cursor 223. This causes entertainment consumption timeline 200 to display information related to movies. This is illustrated by entertainment content identifiers that show the titles of movies 246 and names of actors 248. The movie titles may indicate specific movies viewed by a user during the displayed time frame, and the names of actors may indicate actors that appear frequently in entertainment content consumed by the user. Further, future events determined to be of interest, such as a release of a movie with actors/genre/etc. that have been frequently consumed by the user in the past, may be displayed with an entertainment content identifier 250 shown in a future region of time axis 202. It will be understood that the type of information displayed via the entertainment content identifiers may vary depending upon the time scale illustrated by time axis 202. For example, where a time scale of decades is illustrated, information regarding genres of movies may be displayed, rather than titles of movies.

In some embodiments, the user interface may include one or more predefined filters that allow a user to search for specific content based upon a content-specific term for a relevant time period. For example, as illustrated at 252 in FIG. 4, a user interface may initially show a “Do you remember” message, and also one or more events or eras relevant to the user's past. As a more specific example, the depicted embodiment shows user interface control that reads “Do you remember the summer of love?”, illustrated as a pull-down option from a “Do you remember” interface control. It will be understood that a single pull-down option is shown for clarity, and that such a filter may have any number of selectable preset options displayed in any suitable manner.

Upon receiving a user selection of this user interface control, a predefined filter filters that user's entertainment history data (or other selected collection of data) for music (for example) popular in the summer of 1967. The resulting songs, albums, and/or artists may be displayed along time axis 202. In some embodiments, the user interface likewise may include a text search window (not shown) that allows a user to perform text-based searching for results to display in entertainment consumption timeline 200.

Other examples of user interface controls include, but are not limited to, controls associated with specific date ranges shown on the timeline. For example, referring to FIGS. 3-4, a user may view all entertainment consumed in January 2010 by selecting the “JAN” control displayed below the timeline. It will be understood that any other suitable user interface control may be used to enable interaction with entertainment consumption timeline 200 in any suitable manner.

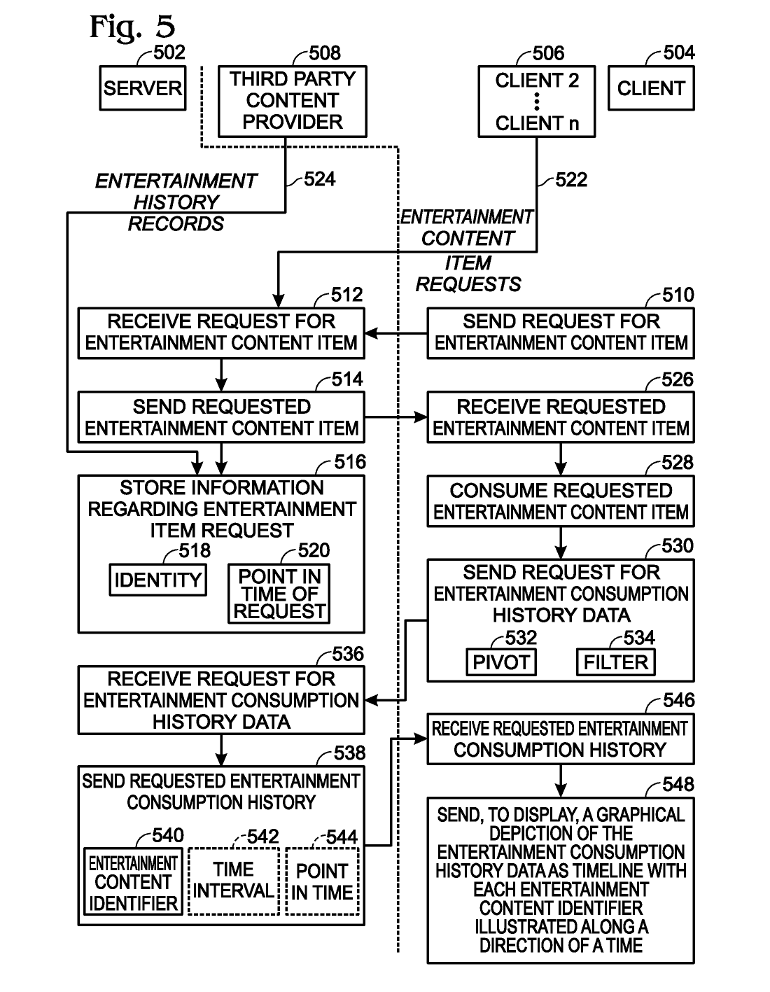

FIG. 5 shows an embodiment of a method 500 of presenting an entertainment consumption timeline. The method shows events and processes that occur at an entertainment server 502 separated by a dashed line from events and process that occur at or arise from a client 504, other clients 506, and third party content providers 508.

At 510, client 504 sends a request to entertainment server 502 for an entertainment content item. Entertainment server 502 receives the request at 512, and in response, at 514, sends the requested entertainment content item to client 504 from which the request was received. The entertainment server also stores, at 516, a record of information related to the entertainment content item request. The record may comprise any suitable information, including but not limited to an identity 518 of the requested entertainment content item, and information related to point in time 520 at which the requested entertainment content item was send to, sent to, or consumed by client 504. This information may then be later used to produce a requested entertainment consumption history.

It will be understood that reference herein to a point in time at which a requested entertainment item is “sent to” or “received by” a client may signify any suitable information regarding the timing of a provision and/or consumption of an entertainment content item, including but not limited to a receipt of an entertainment item request, a sending of the entertainment item to the requesting client, and/or a consumption of the entertainment content item by the client, and that either of these terms are to be interpreted to include any such timing. It will further be understood that processes 510-516 may be performed for each of a plurality of entertainment content item requests received over a period of time from the client.

As mentioned above, entertainment consumption history data for a user may be received from other entities than client 504 for storage as part of a user's entertainment consumption history data. For example, a user also may use other clients, represented at 506 as an arbitrary number n of other clients (e.g. a mobile device client, a laptop client, etc.) to request and receive entertainment content. These requests are illustrated at 522. In this case, a user's account identity may be used to associate entertainment content item requests from different client devices with a single user. Also, a user may request and receive content from one or more third party content providers 508. Such other entertainment content item requests may be obtained by the media server, as indicated at 524, through partnerships with the third party providers (e.g. in bulk), by request or other action of the user, etc.

At 526, client 504 receives the requested media content item. The media content item may then be consumed by the user, as shown at 528. At some later time, as illustrated at 530, client 504 sends a request for entertainment consumption history data, as indicated at 530. The request may be sent, for example, upon receipt of a user input explicitly requesting display of an entertainment consumption timeline, upon launch of an entertainment content discovery user interface that incorporates an entertainment consumption timeline, or upon any other suitable action or occurrence. The request may be for a user's entire entertainment consumption history, or for only a portion of the entertainment consumption history as defined by a user-selected pivot 532 or filter 534. Such a pivot or filter may specify a desired time frame for the history, a desired media type to show in the history, and/or any other suitable parameters.

In some embodiments where another user has elected to share his or her entertainment consumption history with other members of a social network, or even the public, the requested entertainment consumption history may be for a user other than the requesting user. As such, the term “selected user” as used herein to refer to an association with a requested entertainment consumption history signifies that a requested entertainment consumption history may or may not be the requesting user's own history. It will be understood that privacy settings may be provided that allow a user to control various privacy-related features. For example, privacy settings may allow a user to elect whether to share an entertainment consumption history with other users, to select a group of users with whom sharing is permitted, to set different levels of privacy for different groups of users, etc. Such controls also may allow a user to elect to have media server 502 not save information related to entertainment item requests where privacy is desired. Such a privacy mode may either be a default mode or an opt-in mode.

Further, in some embodiments, the requested entertainment consumption history may comprise aggregated information from a plurality of users that is presented without any personally identifiable information. In this manner, a user may see items that are popular with other users without viewing any information about such other users.

Media server 502 receives the request for the entertainment consumption history data at 536, and then sends the requested entertainment consumption history for the selected user to client 504 at 538. The requested entertainment consumption history data may include any suitable information. For example, the requested entertainment consumption history data may comprise one or more entertainment content identifiers that each identifies one or more entertainment content items previously sent to the selected user. It will be understood that, where the request for the entertainment consumption history is received from a user other than the selected user, the method may comprise verifying that the user from which the request was received is allowed to access the media consumption history before sending the media consumption history.

Furthermore, as indicated at 542, the requested entertainment consumption history data may comprise, for each entertainment content identifier, information related to a time at which the one or more entertainment content items identified by the entertainment content identifier were sent to by the selected user. Where a entertainment content identifier identifies a common characteristic of a plurality of entertainment content items, such information may comprise information related to a time interval over which the plurality of entertainment items were sent to the user, as indicated at 542. Likewise where the entertainment content identifier identifies a single entertainment content item, the information related to time, may comprise a point in time at which the entertainment content item was sent to the user, as indicated at 544. It will be understood that the term “point in time” as used here may refer to an approximate time (e.g. hour, day, week, etc.) that a specified entertainment content item was sent to a user, and is used to distinguish the time data associated with the sending of a single item from time data associated with sending plural items represented by a single “common characteristic” entertainment content identifier.

Next, the entertainment consumption history is received at 546 by client 504. Then, client 504 sends to a display device a graphical depiction of the entertainment consumption history data as a timeline with each entertainment content identifier being illustrated along a direction of a time axis at a location representative of the time at which the one or more entertainment content items represented by the entertainment content identifier were received by the selected user. Non-limiting example embodiments of such timelines are described above with reference to FIGS. 2-4.

As described above, the entertainment content identifiers in the entertainment consumption history may each identify one or more entertainment content items. For example, a selected entertainment content identifier in the entertainment consumption history may identify a common characteristic of a plurality of entertainment content items previously received by the selected user. As such, this selected entertainment content identifier may be displayed along a time axis at a location representative of a time interval during which the user received the plurality of entertainment content items. Examples of such common characteristics include, but are not limited to, a genre and an artist common to the entertainment content items. Other selected entertainment content identifiers may identify single entertainment content items (e.g. specific albums, songs, movies, television shows, games, etc.)

In some embodiments, another selected entertainment content identifier may represent a future entertainment content identifier. Such a future entertainment content identifier may be selected for a user based upon a user's past entertainment consumption history, and/or on explicit tags, requests, criteria etc. provided by the user. It will be understood that the future entertainment content identifier may be displayed at a location representative of the time at which the future entertainment content item will become available for consumption.

As described above, in some embodiments a client may present an entertainment consumption timeline to a user along with various user interface controls that allow a user to interact with the timeline, as well as with content shown in the timeline. For example, such controls may include, but are not limited to, pan controls, zoom controls, interactive content displayed in the timeline itself (i.e. entertainment content identifiers with which a user can interact to transform the timeline into another user experience, such as an album playback, ticket purchasing experience, etc.), filters, pivots, and any other suitable control.

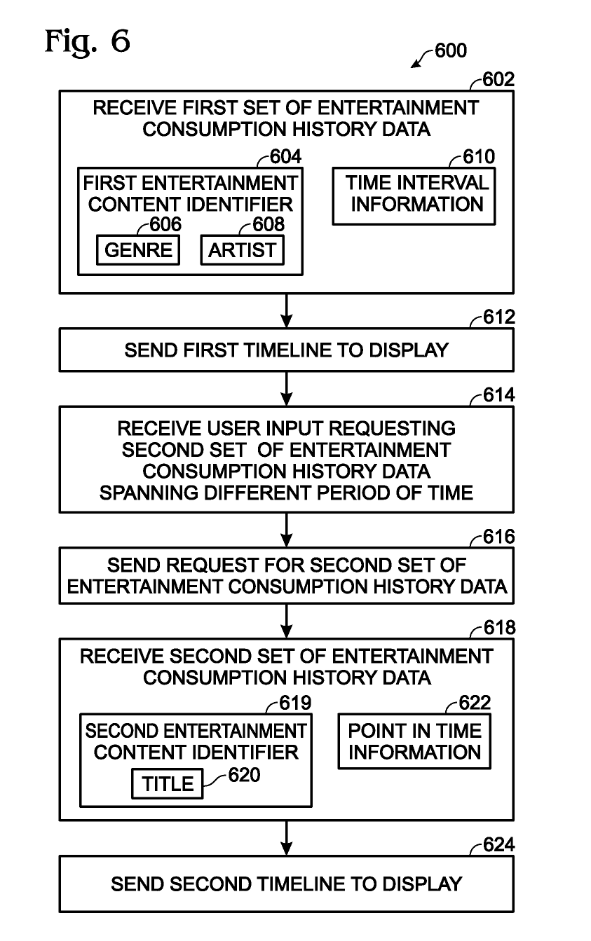

FIG. 6 shows an embodiment of a method 600 of presenting an entertainment consumption timeline to a user in which the user interacts with a user interface zoom control to transform the displayed entertainment consumption timeline. Method 600 comprises, at 602, receiving a first set of entertainment consumption history data from an entertainment server. The first set of entertainment consumption history data comprises a first entertainment content identifier 604 identifying a common characteristic of two or more entertainment content items sent to a selected user. Examples of identifier 604 may include, but are not limited to, a genre 606 and an artist 608 common to the two or more entertainment content items. The first set of entertainment consumption history also comprises, at 610, information related to a time interval during which the two or more entertainment content items identified by the entertainment content identifier were sent to the selected user.

Method 600 next comprises, at 612, sending to a display a graphical depiction of the first set of entertainment consumption history data as a first timeline with the first entertainment content identifier illustrated along a time axis at a location representative of the time interval. Examples of suitable graphical depictions of such timelines include, but are not limited to, those examples described above with respect to FIGS. 2-4.

Next, method 600 comprises, at 614, receiving a user input requesting a second set of entertainment consumption history data spanning a period of time than the first set of entertainment consumption history data. Such a user input may comprise, for example, a user adjusting a zoom control by moving a slider, selecting a predetermined zoom level, etc., thereby changing a time span displayed via the timeline.

In response to receiving the user input, method 600 next comprises, at 616, sending a request for the second set of entertainment consumption history data. In some embodiments, this request may be sent to the server where the data set received at 602 does not include this data. In other embodiments, a complete timeline comprising all of a user's entertainment consumption history may be received at 602. In this case, process 616 may be performed locally.

Next, at 618, method 600 comprises receiving the second set of entertainment consumption history data. Where a user has zoomed the view inward to show more detail in the timeline, the second set of entertainment consumption history data may comprise a second entertainment content identifier 619 identifying a title 620 of a selected entertainment content item sent to the selected user during the second interval of time. The second set of entertainment consumption history also may comprise information related to a point in time 622 at which the selected entertainment content item was sent to the selected user. Method 600 then comprises, at 624, ceasing display of the first timeline and sending to the display a graphical representation of the second set of entertainment consumption history data as a second timeline with the second entertainment content identifier illustrated along the time axis at a location representative of the point in time at which the selected entertainment content item was sent to the selected user.

Thus, by zooming the view in with the zoom control, a user may view more detailed information (e.g. the second entertainment content identifier) than that presented in the first timeline at the wider zoom (e.g. the first entertainment content identifier). It will be understood that a user may zoom out to reverse this process and view a more general depiction of the user's entertainment consumption history.

Using the embodiments disclosed herein, it will be understood that a user may enjoy various interactions with an entertainment consumption timeline not enabled by current methods of presenting media activity histories. For example, a user may view media consumed from a specific time period (year, decade, etc.), and also easily locate specific media items consumed in the past. Further, a user can easily share any desired portion of his or her entertainment consumption history via sharing settings provided by a media server and/or client. Additionally, a user may be able to easily discover future entertainment items of interest. Also, to help ensure the relevancy of recommended future entertainment items, a personalization management interface may be provided that allows a user to browse through the entertainment consumption history and specify whether individual items are to influence recommendations and other personalization experiences.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer-readable medium comprising instructions stored thereon that are executable by a computing device to:
receive entertainment consumption history data from an entertainment server, the entertainment consumption history data comprising
one or more entertainment content identifiers each identifying one or more entertainment content items sent to a selected user, and
for each entertainment content identifier, information related to a time at which the one or more entertainment content items identified by the entertainment content identifier was sent to the selected user; and
send to a display device a graphical depiction of the entertainment consumption history data as a timeline with each entertainment content identifier being illustrated along a direction of a time axis at a location representative of the time at which the one or more entertainment content items represented by the entertainment content identifier were sent to the selected user.

2. The computer-readable medium of claim 1, wherein the instructions are executable to receive a selected entertainment content identifier that identifies a title of a selected entertainment content item previously sent to the selected user, and to display the selected entertainment content identifier at a location representative of the point in time at which the user was sent the selected entertainment content item.

3. The computer-readable medium of claim 1, wherein the instructions are executable to receive a selected entertainment content identifier that identifies a common characteristic of a plurality of entertainment content items previously sent to the selected user, and to display the selected entertainment content identifier at a location representative of a time interval during which the user received the plurality of entertainment content items.

4. The computer-readable medium of claim 3, wherein the common characteristic comprises one or more of an artist and a genre.

5. The computer-readable medium of claim 1, wherein the instructions are executable to receive a future entertainment content identifier that identifies a future entertainment content item available for future consumption, to receive information related to a time that the future entertainment content item will become available for consumption, and to display the future entertainment content identifier at a location along the direction of the time axis at a location representative of the time at which the future entertainment content item will become available for consumption.

6. The computer-readable medium of claim 1, wherein the instructions are executable to:
send to the display device a graphical representation of a zoom control for a graphical user interface;
receive a user input selecting the zoom control;
in response to the user input, change a length of a time interval displayed by the timeline.

7. The computer-readable medium of claim 6, wherein, in response to the user input selecting the zoom control, the instructions are executable to cease display of a first selected entertainment content identifier that identifies a common characteristic of a plurality of entertainment content items, and to begin display of a second selected entertainment content identifier that identifies a single entertainment content item.

8. The computer-readable medium of claim 1, wherein the instructions are executable to:
send to the display device a graphical representation of a pan control for a graphical user interface;
receive a user input selecting the pan control; and
in response to the user input, change a location of a time interval displayed by the timeline.

9. The computer-readable medium of claim 1, wherein the instructions are executable to:
receive a user input selecting a selected entertainment content identifier;
contact the entertainment server requesting the entertainment content item;
receive the entertainment content item; and
present the entertainment content item.

10. The computer-readable medium of claim 1, wherein the instructions are executable to:
send to the display device a graphical representation of two or more media type pivot user interface controls;
to receive a user input of a selected pivot; and
to display, via the timeline, entertainment content identifiers related to a media type corresponding to the selected pivot.

11. A computing system, comprising:
a logic subsystem; and
a data storage subsystem comprising instructions stored thereon that are executable by the logic subsystem to:
receive a first set of entertainment consumption history data from an entertainment server, the first set of entertainment consumption history data comprising
a first entertainment content identifier identifying a common characteristic of two or more entertainment content items sent to a selected user, and
information related to a time interval during which the two or more entertainment content items identified by the entertainment content identifier were sent to the selected user;
send to a display a graphical depiction of the first set of entertainment consumption history data as a first timeline with the first entertainment content identifier illustrated along a time axis at a location representative of the time interval;
receive a user input requesting a second set of entertainment consumption history data spanning a different length of time than the first set of entertainment consumption history data;
in response to receiving the user input, sending a request for the second set of entertainment consumption history data;
receive the second set of entertainment consumption history data from the entertainment server, the second set of entertainment consumption history data comprising
a second entertainment content identifier identifying a title of a selected entertainment content item sent to the selected user during the second interval of time, and
information related to a point in time at which the selected entertainment content item was sent to the selected user; and
send to the display a graphical representation of the second set of entertainment consumption history data as a second timeline with the second entertainment content identifier illustrated along the time axis at a location representative of the point in time at which the selected entertainment content item was sent to the selected user.

12. The computing system of claim 11, wherein the computing device is one of a mobile device, a desktop computer, a laptop computer, a notebook computer, and a television system.

13. The computing system of claim 11, wherein the user input is received via a zoom control displayed on a user interface on the display.

14. An entertainment server, comprising:
a logic subsystem; and
a data storage subsystem comprising instructions stored thereon that are executable by the logic subsystem to:
receive, over a period of time, a plurality of entertainment content item requests from a selected user via one or more media clients;
in response to each entertainment content item request,
send a requested entertainment content item to a media client from which the request was received,
store a record of the entertainment content item request, and
store information related to a point in time at which the entertainment content item was sent;
receive a request for an entertainment consumption history for the selected user; and
in response to the request for the entertainment consumption history, send an entertainment consumption history comprising one or more entertainment content identifiers that each identifies one or more entertainment content items previously sent to the selected user and also comprising information related to a time at which the one or more entertainment content items was sent to the selected user.

15. The entertainment server of claim 14, wherein a selected entertainment content identifier of the plurality of entertainment content identifiers identifies a single entertainment content item.

16. The entertainment server of claim 14, wherein a selected entertainment content identifier of the plurality of entertainment content identifiers identifies a plurality of entertainment content items by a common characteristic of the plurality of entertainment content items.

17. The entertainment server of claim 16, wherein the common characteristic comprises one or more of an artist and a genre.

18. The entertainment server of claim 14, wherein the instructions are executable to determine a future entertainment content identifier that identifies a future entertainment content item available for future consumption.

19. The entertainment server of claim 14, wherein the selected user is a user other than a user from which the request for the media consumption history was received, and further comprising verifying the user from which the request was received is allowed to access the media consumption history before sending the media consumption history.

20. The entertainment server of claim 14, wherein the instructions are executable to receive one or more media history records for the selected user in bulk from a third party.
